(19) United States
(12) Patent Application Publication
(10) Pub. No.: US 2010/0212920 A1
(43) Pub. Date: Aug. 26, 2010

(54) INERT GAS FLOODING FIRE SUPPRESSION WITH WATER AUGMENTATION

(75) Inventors: Muhidin A. Lelic, Londonderry, NH (US); Giuliano Amantini, East Haven, CT (US); May L. Corn, Manchester, CT (US); Robert G. Dunster, Slough (GB); Yehia F. Khalil, Glastonbury, CT (US); Robert J. Lade, Marlow (GB); Ravi K. Madabhushi, Longmeadow, MA (US); Marios C. Soteriou, Middletown, CT (US); Seth Sienkiewicz, Franklin, MA (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: UTC Fire & Security, Farmington, CT (US)

(21) Appl. No.: 12/678,875

(22) PCT Filed: Sep. 24, 2007
(86) PCT No.: PCT/US07/20604

§ 371 Date: Mar. 18, 2010

(51) Int. Cl. A62C 3/00

(52) U.S. Cl. 169/46; 169/56

(57) ABSTRACT

A method and system are provided for suppressing a fire inside a defined volume within a structure. To suppress a fire, the defined volume is flooded with a flow of inert gas into which a limited amount of water is introduced into the flow of inert gas; the flow of inert gas and the limited amount of water introduced therein being sufficient to establish a fire extinguishing atmosphere within the defined volume having a volumetric oxygen concentration of at least about 14%. A cartridge for storing a limited amount of water has a water outlet in flow communication with a spray nozzle that is in flow communication with a supply of pressurized inert gas. The water storage cartridge has a gas inlet in flow communication with a supply of pressurized inert gas for pressurizing the water storage cartridge to cause water to flow therefrom to the spray nozzle.

### CROSS REFERENCE TO RELATED APPLICATION

This application is related to International Patent Application Serial No. PCT/US07/(Attorney Docket No. 1463_{—}002), entitled “HYBRID INERT GAS FIRE SUPPRESSION SYSTEM”, filed with the United States Patent and Trademark Office on the same date as this application and subject to assignment to the common assignee of this application.

### FIELD OF THE INVENTION

This invention relates generally to fire suppression systems. More particularly, this invention relates to a fire suppression system providing inert gas flooding fire suppression with water augmentation.

### BACKGROUND OF THE INVENTION

Fire suppression fire systems are often installed in commercial buildings. Typically, those buildings are subdivided into multiple rooms. Commonly, conventional fire suppression systems are designed either as total flooding systems using an inert gas under pressure or localized streaming fire suppression systems using liquid suppressant under pressure. In total flooding systems, an inert gas is rapidly admitted into a room, commonly through a plurality of nozzles mounted in an array in the ceiling of the room, to fill the volume defined within the room. The inert gas may be nitrogen, carbon dioxide, argon, neon, helium or other chemically non-reactive gas, or mixtures of any two or more of these gases. For example, a mixture of 50% argon and 50% nitrogen is commonly used in inert gas fire suppression system. The inert gas not only removes heat from the fire, but also dilutes the oxygen content within the room to a level low enough that combustion can not be sustained. Typically, conventional inert gas systems are sized to reduce the oxygen content in the atmosphere within the environment of the protected area to a level below 12.5 percent within one minute. Consequently, a large number of high-pressure cylinders of inert gas, typically at a pressure between 200 to 300 bars must be provided to store the necessary volume of inert gas. A large centralized storage area must be dedicated for placement of the required inert gas storage cylinders.

Conventional streaming fire suppression systems spray a mist of liquid suppressant over a localized area beneath the spray cone of a distribution nozzle. Commonly, a number of distribution spray nozzles are arrayed over the space being protected and are supplied with liquid suppressant, for example water or a liquid chemical agent, from a centralized source. Typically, the liquid suppressant is fed under pressure and conveyed through a network of pipes to the various individual distribution nozzles. Generally, the distribution nozzles are designed to emit a mist of liquid suppressant having a droplet size in the range of between 5 and 60 micrometers. The mist may be produced simply by forcing the liquid suppressant through the openings of the nozzle or through atomization means incorporated in the nozzle.

U.S. Patent Application Publication No. US2005/073131A1 discloses a fire and explosion suppression system wherein high pressure water from a central storage tank is suspended in a flow of nitrogen gas or a mixture of nitrogen and argon gases and distributed to an array of a plurality of distribution nozzles and emitted as a mist of water droplets over a localized area. U.S. Patent Application Publication No. 2006/0278410 discloses a fire and explosion system wherein high pressure water from a central storage tank is passed through a network of pipes to a plurality of high velocity low pressure emitters wherein the water is atomized and discharged into a high pressure inert gas stream passing out of the emitter. U.S. Pat. No. 7,153,446, also published as Patent Application Publication No. US2005/0144949A1, discloses a fire and explosion suppression system wherein a liquid chemical agent fire suppressant under pressure from a central storage tank is suspended in a flow of inert gas and is distributed to an array of a plurality of distribution nozzles and emitted as a mist of liquid droplets over a localized area. A number of exemplary liquid chemical agents suitable for use as fire suppressants are also disclosed in U.S. Pat. No. 7,153,446.

A form of fire suppression system using a commercially available liquid chemical fire suppressant is commonly referred to as a clean agent gaseous fire suppression system because the chemical agent leaves no residue upon evaporation. Clean agent fire suppression systems are often installed in rooms or areas of buildings wherein equipment or goods are housed that could be damaged by water, powder or foam. In a system of this type, a chemical fire suppression agent that is stored in a tank or cylinder as a liquid under pressure is pushed by a gaseous propellant, typically nitrogen, argon or carbon dioxide, from a tank or cylinder of propellant arranged in series flow relationship with the tank or cylinder of chemical agent, through a network of pipes to and through a plurality of distribution nozzles arrayed across the ceiling area or walls of the space being protected. The chemical fire suppression agent is a volatile chemical that exists as a liquid when confined under pressure in a closed vessel, but rapidly vaporizes from its liquid state to a vapor state when sprayed via the distribution nozzles into the ambient atmosphere to form a gaseous mixture with the air within the space being protected which does not support combustion and extinguishes fires. The distribution nozzles function to atomize or otherwise break the liquid chemical fire suppressant into small droplets to facilitate evaporation. An example of a clean agent gaseous fire suppression system is disclosed in each of U.S. Pat. No. 6,763,894 and U.S. Patent Application Publication No. US2005/0001065A1.

### SUMMARY OF THE INVENTION

In an aspect of the invention, a method is provided for suppressing a fire inside a defined volume within a structure, including the steps of flooding the defined volume with a flow of inert gas, and introducing a limited amount of water into the flow of inert gas. The flow of inert gas introduced into the defined volume and the limited amount of water introduced therein are sufficient to establish a fire extinguishing atmosphere within the defined volume having a volumetric oxygen concentration of at least about 14%. The amount of water introduced into the flow of inert gas may be limited to a volumetric ratio of the volume of water to the volume of inert gas in the range of about 0.02% to 0.05%. The step of flooding the defined volume with a flow of inert gas may comprise the step of flooding the defined volume with a flow of chemically non-reactive gas selected from the group including nitrogen gas, carbon dioxide gas, helium gas, argon gas, neon gas, and mixtures of two or more thereof.

In an aspect of the invention, a method is provided for suppressing a fire inside a defined volume within a structure, including the steps of: storing a supply of inert gas under pressure, providing at least one inert gas spray nozzle within the defined volume, storing a supply of water in a reservoir in the vicinity of the at least one inert gas spray nozzle, detecting a fire within the defined volume, flooding the defined volume with pressurized inert gas by passing a flow of pressurized inert gas from the supply of inert gas through the at least one inert gas nozzle, and pressurizing the water reservoir with a flow of pressurized inert gas from the supply of inert gas to force a flow of water from the water reservoir into the flow of pressurized inert gas. In an embodiment, the method further includes the step of introducing water from the water reservoir directly into the inert gas flow upstream of the spray nozzle. In an embodiment, the method further includes the step of introducing water from the water reservoir into the inert gas flow passing from the spray nozzle.

In another aspect of the invention, a fire suppression system is provided for establishing a fire extinguishing atmosphere within a defined volume in response to detection of a fire within the defined volume. The fire suppression system includes at least one inert gas spray nozzle assembly for introducing a flooding flow of inert gas into the defined volume and a water storage cartridge defining a reservoir for storing a limited amount of water. The inert gas spray nozzle assembly includes a spray nozzle that is disposed within the defined volume and connected in flow communication with a supply of pressurized inert gas. The water storage cartridge is disposed in close proximity to the spray nozzle and has a pressurizing gas inlet in flow communication with the supply of pressurized inert gas and a water outlet in flow communication with said spray nozzle.

In an embodiment, the water storage cartridge has an elongated body extending along a longitudinal axis between an aft end and a forward end and having an interior volume defining the water reservoir. The forward end of said body may be disposed adjacent the spray nozzle. A gas flow conduit establishes flow communication between the supply of pressurized inert gas and the interior volume of the water storage cartridge through an outlet opening to the interior volume of the water storage cartridge through an upper portion of the aft end of the water storage cartridge. A water conduit establishes flow communication between the interior volume of the water storage cartridge and the spray nozzle through an inlet opening to the interior volume of the water storage cartridge through a lower portion of the forward end of the water storage cartridge. In an embodiment, the water conduit has an outlet opening into an interior cavity of the spray nozzle. A flow restriction orifice may be disposed in the water conduit. In an embodiment, a gas flow restriction orifice may be disposed in the inert gas supply line between the gas conduit opening thereto and the water conduit opening thereto.

In an embodiment of the fire suppression system, an inert gas supply pipe in flow communication with the supply of pressurized inert gas has a terminus to which the spray nozzle is mounted and a water conduit establishes flow communication between the interior volume of the water storage cartridge and the spray nozzle. The water conduit has an inlet opening to the interior volume of the water storage cartridge through a lower portion of the forward end of the water storage cartridge and an outlet opening into a terminal portion the inert gas supply pipe upstream with respect to inert gas flow therethrough of the spray nozzle. A gas flow conduit establishes flow communication between the supply of pressurized inert gas and the interior volume of the water storage cartridge through an inlet opening to an upstream portion of the terminal portion of the inert gas supply pipe and an outlet opening to the interior volume of the water storage cartridge through an upper portion of the aft end of the water storage cartridge. A flow restriction orifice may be disposed in the terminal portion of the inert gas supply pipe downstream with respect to inert gas flow of the inlet of the gas conduit to the terminal portion of the inert gas supply line and upstream with respect to inert gas flow of the outlet of the water conduit to the terminal portion of the inert gas supply pipe.

### BRIEF DESCRIPTION OF THE DRAWINGS

For a further understanding of these and other objects of the invention, reference will be made to the following detailed description of the invention which is to be read in connection with the accompanying drawing, where:

FIG. 1 is a depiction, partly is schematic and partly in perspective, of an exemplary embodiment of a fire suppression system in accord with the invention;

FIG. 2 is a sectioned side elevation view of the first embodiment of the nozzle assembly depicted in FIG. 1;

FIG. 3 is a sectioned elevation view of the spray nozzle shown in FIG. 2;

FIG. 4 is a sectioned side elevation view of the second embodiment of the nozzle assembly depicted in FIG. 1;

FIG. 5 is a sectioned elevation view of the spray nozzle shown in FIG. 4;

FIG. 6 is a bar graph illustrating the oxygen content of a fire extinguishing atmosphere for the hybrid inert gas fire suppression system of the invention in comparison to conventional Nitrogen and Argon/Nitrogen inert gas fire suppression systems; and

FIGS. 7A, 7B and 7C are schematic illustrations of three respective exemplary embodiments depicting alternate locations of the water storage cartridge relative to the inert gas distribution network of the hybrid inert gas fire suppression system of FIG. 1.

### DETAILED DESCRIPTION OF THE INVENTION

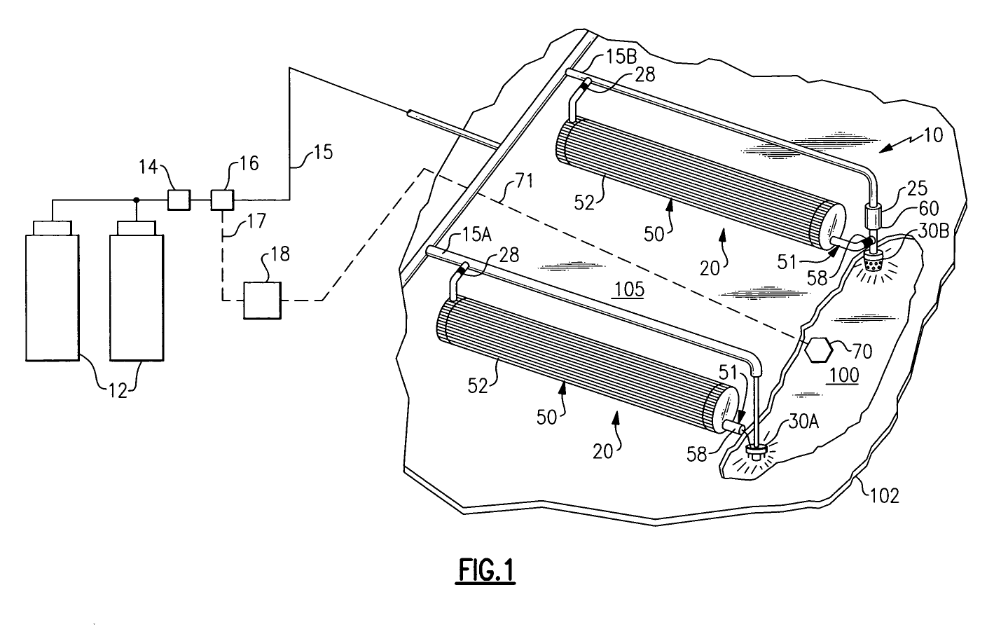

Referring now to FIGS. 1-5 in particular, there is depicted an exemplary embodiment of a hybrid inert gas fire suppression system 10 with water augmentation in accord with the invention. The system 10 includes one or more vessels 12 for storing an inert gas, i.e. a chemically non-reactive gas, such as nitrogen, argon, neon, helium, carbon dioxide or a mixture of two or more of these gases, and at least one spray nozzle assembly 20. Although two spray nozzle assemblies 20 are depicted in the exemplary embodiment of the system 10 illustrated in FIG. 1, it will be understood by those skilled in the art that the actual number of spray nozzle assemblies installed in any particular application will depend upon the volume and planar area of the protected space.

The inert gas storage vessels 12, each of which contains inert gas under pressure, typically at a pressure of 200 to 300 bars, are connected in flow communication with the spray nozzle assemblies 20 via a network of pipes 15, 15A and 15B. The pipes 15A and 15B, each of which branches off the main inert gas supply pipe 15 to feed inert gas to a respective one of the spray nozzle assemblies 20, may be referred to as a distribution pipe. As in conventional inert gas fire suppression systems, a pressure regulator 14 is disposed at the outlet of each of the inert gas vessels 12 for regulating the pressure leaving the inert gas vessels 12 to maintain an initial desired gas pressure within the inert gas flow line, typically up to 150 bars. A gas flow regulator 16 is disposed in pipe 15 downstream of the pressure regulator 14 for controlling the flow of inert gas through the pipe 15. Alternatively, the gas pressure regulator 14 and the gas flow regulator 16 may be collocated or even combined into a single valve or flow control device. A sensor 70 may be installed within the protected space 100 for detecting the existence of a fire within the protected space and for generating a fire detected signal. When a fire is detected, a fire detected signal 71 is transmitted from the sensor 70 to the system controller 18 which, in response to receipt of the fire detected signal 71, generates the demand signal 17 and transmits the demand signal 17 to the gas flow regulator 16 which, in response to receipt of the demand signal 17, opens to allow pressurized inert gas from the vessels 12 to flow through the pipes 15, 15A and 15B to the respective spray nozzle assemblies 20.

Each of the spray nozzle assemblies 20 includes a spray nozzle 30A or 30B mounted to the terminus of the terminal section of a respective one of the distribution pipes 15A and 15B that branch off of the inert gas supply pipe 15. The spray nozzle assemblies 20 are disposed above the ceiling 102 of the protected space 100 in the open space 105 that exists above the ceiling 102 and beneath the floor 104 of the next story thereabove or the roof of the structure, commonly referred to as the ceiling void. As in conventional practice, the terminal section of each of the branch pipes 15A and 15B extends generally vertically downward such that the spray nozzles 30A or 30B are disposed subadjacent the room-side, i.e. lower side, surface of the ceiling 102 extending over the protected space 100.

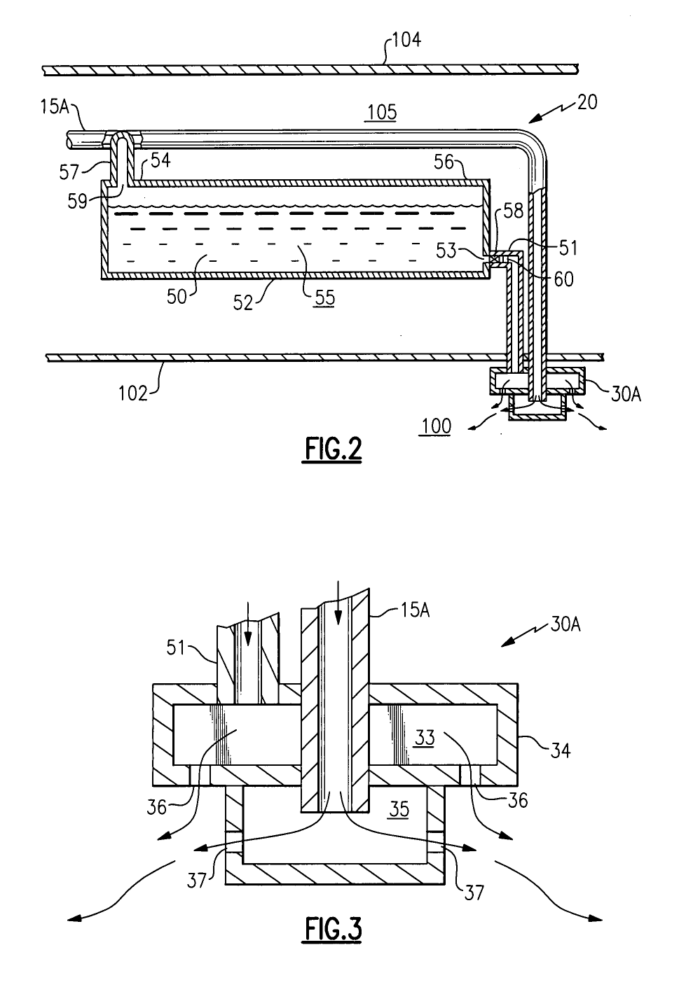

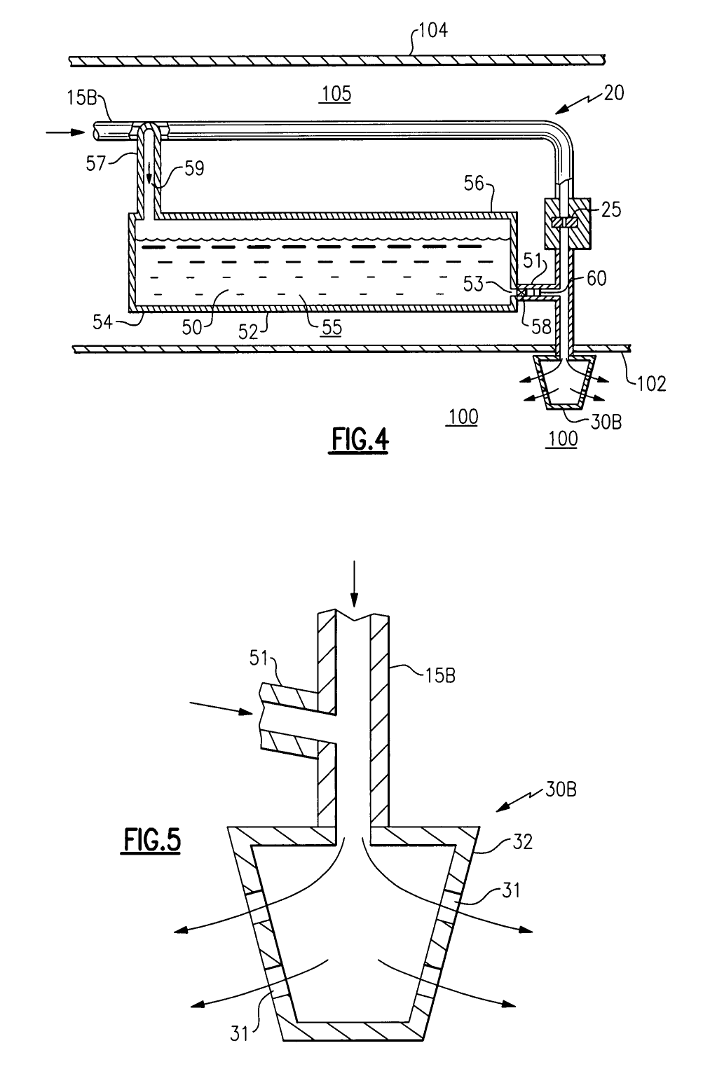

Each of the spray nozzle assemblies 20 of the hybrid inert gas flooding fire suppression system 10 of the invention further includes a reservoir of water 50 disposed in the ceiling void 105 in operative association with its respective one of the spray nozzles 30A and 30B. The reservoir of water 50 is stored at atmospheric pressure within the interior volume 55 of an elongated cartridge 52 having an aft end 54 and a forward end 56. As depicted in the exemplary embodiments shown in FIGS. 2 and 4, the water storage cartridge may be a cylinder. However, it is to be understood that the water storage cartridge could be in the form of a sphere, a rectangular parallelepiped, or any other suitable form. In the exemplary embodiments depicted in FIGS. 2 and 4, the cartridge 52 is disposed in association with the terminal section of each of the respective branch pipes 15A and 15B with the forward end 56 of the water storage cartridge 52 disposed in neighboring relationship with the spray nozzle 30A, 30B of the spray nozzle assembly 20. However, as will be discussed in further detail hereinafter, the water storage cartridges 52 may alternatively be located further upstream on the respective branch pipes 15A and 15B, that is more remote from the respective spray nozzles 30A and 30B rather than being located in association with the terminal section of the branch pipes 15A and 15B.

In the exemplary embodiment depicted in FIGS. 2 and 3, the spray nozzle 30A is a dual fluid atomizer having a body 34 defining an upper cavity 33 and a lower cavity 35. Water from the reservoir 50 passing through conduit 53 is introduced directly into the upper cavity 33 and inert gas is introduced directly into the lower cavity 35. A plurality of openings 37 through the lower side wall of the nozzle body 34 provide a plurality of circumferentially spaced outlets through which inert gas passes from the lower cavity 35. The inert gas enters the lower cavity 35 traveling generally vertically downward and turns to follow along the floor of the lower cavity and exit generally horizontally in the protected space 100 through the openings 37. Water exits from the upper cavity 33 generally vertically downward into the protected space through a plurality of openings 36 extending through the floor of the upper cavity at circumferentially spaced intervals located radially outward of the lower side wall of the nozzle body. As the water passes generally vertically downward, it is impacted by the generally horizontally directed inert gas causing the water to be atomized into a droplet mist and entrained in the inert gas stream to penetrate together with the inert gas into the ambient atmosphere within the protected space 100. It is to be understood that the dual fluid atomizer described herein is merely exemplary and that various other configurations of dual fluid atomizers may be used in connection with the fire suppression system and method of the invention.

In the exemplary embodiment depicted in FIGS. 4 and 5, since the water from the reservoir 50 passing through conduit 51 is introduced into and mixes with the inert gas flow passing through the terminal portion of the distribution pipe 15B upstream of the spray nozzle 30B, the spray nozzle 30B may comprise any conventional distribution-type spray nozzle. For example, the spray nozzle 30B may have a plurality of openings 31, which in the depicted embodiment are arrayed in one or more rows at circumferentially spaced intervals about the body 32 of the spray nozzle. However, it is to be understood, that the openings 31, which may be holes or elongated slots or other shaped apertures, may be arrayed or otherwise disposed in other arrangements. In this type of spray nozzle, atomization of the water entrained in the inert gas flow occurs as a result of the force of the pressure drop encountered as the water/inert gas mix passes through the openings 31 and penetrates into the ambient atmosphere within the protected space 100.

A water conduit 51 establishes water flow communication between the interior volume 55 of the water storage cartridge 52 through an outlet 53 at the lower portion of the forward end 56 of the cartridge 52 and the respective spray nozzle 30A, 30B associated with the cartridge 52. In the exemplary embodiment depicted in FIGS. 2 and 3, the water conduit 51 opens into the upper cavity of the spray nozzle 30A. In the exemplary embodiment depicted in FIGS. 4 and 5, the conduit 51 opens into the terminal portion of the distribution pipe 15B upstream of the spray nozzle 30B and on the upper side of the ceiling 102. A check valve 58 is disposed in the conduit 51 downstream of the outlet 53 from the water storage cartridge 52 to prevent back flow through the conduit 51.

A gas conduit 57 establishes inert gas flow communication between the inert gas distribution line 15A, 15B associated with the water storage cartridge 52 and the interior volume 55 of the cartridge 52 through an inlet 59 at the upper portion of the aft end 54 of the cartridge 52. A back flow prevention means 28, such as a check valve or burst diaphragm, may be disposed in the gas conduit 57 to prevent back flow of water therethrough into gas conduit 57 when the inert gas distribution lines 15A, 15b are not pressurized, that is when inert gas is not flowing therethrough. As depicted in the exemplary embodiment illustrated in FIG. 4, a flow restriction orifice 25 may be inserted in the distribution pipe 15B at a location downstream of the opening of the gas conduit to the distribution pipe 15B and upstream of the opening of the water conduit 53 to the terminal portion of the distribution pipe 15B for the purpose of increasing the pressure drop experienced by the inert gas flowing therethrough thereby further increasing the pressure differential between the pressure of the inert gas admitted to the reservoir 55 within the water storage cylinder 50 and the gas pressure at the downstream location at which the water is emitted from the water storage cartridge 50 into distribution pipe 15B.

As noted previously, when a fire is detected within the protected space 100, the controller 18 sends a demand signal 17 to the flow control valve 16 causing the flow control valve 16 to open, thereby allowing pressurized inert gas to flow from the inert gas storage vessels 12 at a controlled rate through the main supply pipe 15 to and through the distribution pipes 15A and 15B and into the protected space 100 through the spray nozzles 30A and 30B. Additionally, a portion of the inert gas passing through the distribution pipes 15A and 15B passes through the respective gas conduit 57 associated with each spray nozzle assembly 20 to pressure the interior volume 55 of the water storage cartridge 52 thereby forcing water to flow from the water reservoir 50 through water conduit 51 to be introduced into the inert gas as hereinbefore described. As the inert gas is introduced into the interior volume 55 of the water storage cartridge at a gas pressure substantially higher than the gas pressure at the location at which the water is introduced into the inert gas flow, the water within the reservoir 50 will rapidly flow therefrom.

A rapid flow rate of water is desired in order to empty the water from the reservoir 50 within a relatively short period of time, typically one minute or less. To provide a relatively constant flow rate over the short period of time in which the reservoir 50 is to be emptied, a water flow orifice assembly 60 may be disposed in the water conduit 51 downstream of the outlet 53 from the water storage cartridge 52. The orifice is sized appropriately to provide a desired pressure drop sufficient to affect a relatively constant mass flow ratio of water mass flow rate through the water conduit 51 to the inert gas mass flow rate. Due to the high pressure of the inert gas emitted into the interior volume within the water storage cartridge 52, without the orifice present to provide this pressure drop, the water flow through the water conduit 51 will decay over the time period required to empty the reservoir 50 from a relatively high flow rate initially to a relatively low rate near the end of the time period.

In conventional inert gas flooding fire suppression systems, the inert gas not only raises the heat capacity of the atmosphere in the protected space into which the inert gas is introduced, but also reduces the volumetric concentration of oxygen in the atmosphere within the protected space to a level less than 14%, which is generally accepted as a volumetric oxygen concentration that gives personnel within the protected space an adequate opportunity to evacuate the premises. In combination, the increase in heat capacity and reduction in oxygen concentration establishes a fire extinguishing atmosphere within the protected space. Thus, in buildings or other installations equipped with conventional inert gas systems that operate to totally flood the protected space with a fire extinguishing atmosphere, personnel within the protected space at the time of activation of the fire suppression system can safely remain within the protected space for only a short period of time and therefore must rapidly evacuate the protected space.

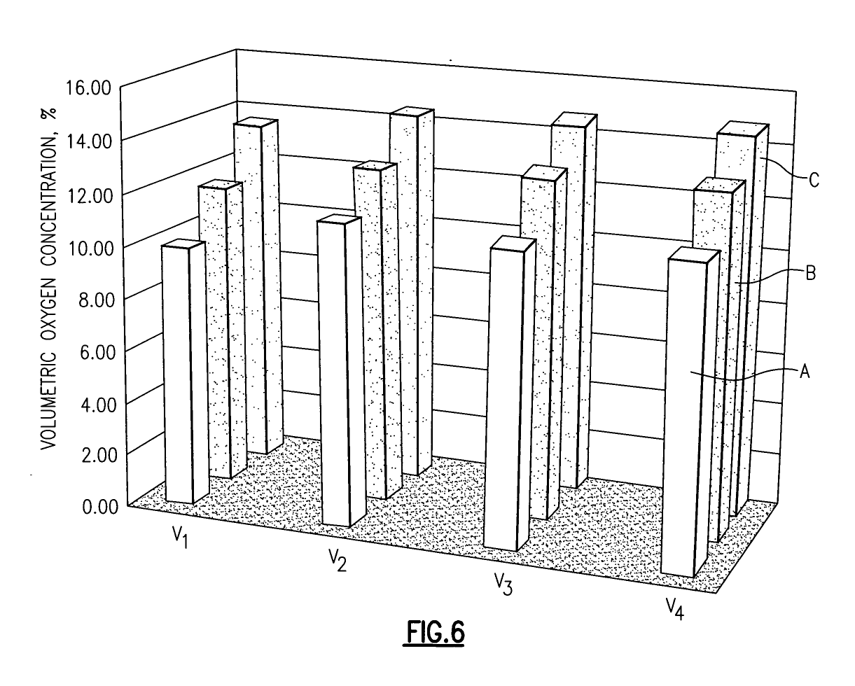

Applicants have found that the admission of a limited amount of water into the inert gas flooding flow results in a hybrid inert gas fire suppression system that not only floods the protected space with an effective fire extinguishing atmosphere, but also provides a safer atmosphere for humans and animals within the protected space. Referring now to FIG. 6, a bar graph is presented that compares the volumetric oxygen concentration characteristically present in the resultant fire extinguishing atmosphere produced when rooms of various volumes are flooded via inert gas from a conventional pure inert gas fire suppression system employing a mixture of equal parts of a nitrogen gas and argon gas, represented by bars A, a conventional pure inert gas fire suppression system employing a nitrogen gas, represented by bars B, and a hybrid inert gas fire suppression system that employs nitrogen gas with water augmentation in accord with the present invention, represented by bars C. As illustrated, the volumetric oxygen concentrations in the fire extinguishing atmosphere produced via the conventional inert gas fire suppression systems, represented by bars A and B, range from slightly less than 9% to about 12.5%.

However, the volumetric oxygen concentrations in the fire extinguishing atmosphere produced via the hybrid inert gas fire suppression system of the invention, represented by bars C, range from about 13% to about 14.5%. Further, for each defined volume, the volumetric oxygen concentration of the fire extinguishing atmosphere produced via the hybrid inert gas fire suppression system of the invention was about 2% higher than the volumetric oxygen concentration characteristic of a conventional pure nitrogen gas fire suppression system (bars B), and about 4% higher than the volumetric oxygen concentration characteristic of a conventional argon/nitrogen gas fire suppression system (bars A). With a higher volumetric oxygen concentration in the resultant fire extinguishing atmosphere, the hybrid inert gas fire suppression system of the invention is safer for humans and animals present in the protected space at the time of activation of the fire suppression system. The higher volumetric oxygen concentration within the resultant fire extinguishing atmosphere improves the conditions and lengthens the time conducive for emergency evacuation, thereby providing personnel within the protected space a better opportunity to safely evacuate the premises.

The added water augments the fire suppression capability of the inert gas by increasing the heat capacity of the resultant fire extinguishing atmosphere as compared to pure inert gas systems. This increase in heat capacity compensates for the lesser reduction in the volumetric oxygen concentration. Thus, the hybrid inert gas fire suppression system of the invention is capable of providing an effective flooding fire extinguishing atmosphere while providing a safer atmosphere for personnel occupying the protected space at the time of activation of the fire suppression system. Additionally, the amount of inert gas required in operation of the hybrid inert gas fire suppression system of the invention is reduced relative to the amount required in a similarly sized conventional inert gas system because the heat capacity of the fire extinguishing atmosphere has been augmented by the water introduced into the inert gas flow. As a result, the amount of inert gas that must be stored for use in connection with an installed inert gas system can be reduced with the hybrid fire suppression system of the invention.

In the hybrid fire suppression system of the invention, the amount of water introduced into the inert gas should be limited. If an excessive amount of water is introduced into the inert gas, the inert gas flooding effect would be lost and the system would operate similar to conventional water streaming fire suppression systems. The amount of water introduced into the flow of inert gas should also be limited to ensure that all of the water is rapidly evaporated upon introduction into the protected space. For example, with the hybrid inert gas fire suppression system of the invention installed in a building for fire suppression within a room having a volume of about 100 cubic meters, to suppress a fire therein, between 4 and 15 liters of water would be introduced into a mass flow of about 30 kilograms of inert gas introduced into the room through a single spray nozzle.

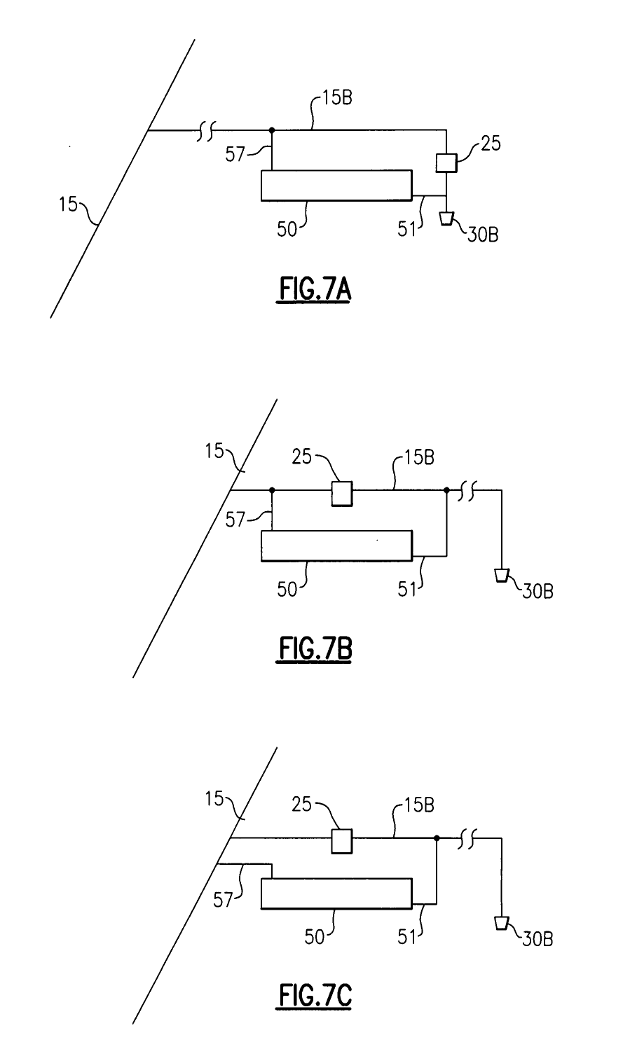

Referring now to FIGS. 7A, 7B and 7C, as noted previously, the water storage reservoir 50 may be located at various locations relative to the inert gas branch pipes and the spray nozzles. In an embodiment, as illustrated in FIG. 7A, the water storage reservoir 50 is disposed in association with the terminal portion of the inert gas branch pipe 15B. In this embodiment, which also reflects the embodiment shown in FIG. 4, the inert gas supply conduit 57 taps into the terminal portion of the inert gas branch line 15B upstream of the water conduit 51 that opens into the terminal portion of the branch line 15B near the terminus thereof to which the spray nozzle 30B is mounted. In the embodiment illustrated in FIG. 7B, however, the water storage reservoir 50 is disposed in association with an upstream portion of the inert gas branch pipe 15B. In this embodiment, the inert gas supply conduit 57 taps into the inert gas branch line 15B upstream of the water conduit 51 that opens into an upstream portion of the branch line 15B, rather than into the downstream terminal portion of the branch line 15B. In the embodiment illustrated in FIG. 7C, the water conduit 51 opens into an upstream portion of the branch line 15B, rather than into the downstream terminal portion of the branch line 15B, and the inert gas supply conduit 57 taps into the inert gas distribution line 15 upstream of the point at which the branch line 15B taps into the inert gas distribution line 15. In each of these embodiments, a gas flow restriction orifice 25 may be disposed in the branch line 15B intermediate the point at which the gas conduit 57 connects and the point at which the water conduit 51 opens into the branch line 15B to impart pressure drop to the to inert gas flow thereby increasing the pressure differential between the location at which the inert gas is drawn off and the location at which the water is admitted to the inert gas flow.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A method of suppressing a fire inside a defined volume within a structure, comprising the steps of:
flooding the defined volume with a flow of inert gas; and
introducing a limited amount of water into the flow of inert gas, the flow of inert gas and the limited amount of water introduced therein being sufficient to establish a fire extinguishing atmosphere within the defined volume having a volumetric oxygen concentration of at least about 14%.

2. A method of suppressing a fire as recited in claim 1 further comprising the step of limiting the amount of water introduced into to the flow of inert gas to a mass flow ratio of the mass flow of water to the mass flow of inert gas in the range of about 0.02% to about 0.05%.

3. A method of suppressing a fire as recited in claim 1 wherein the step of flooding the defined volume with a flow of inert gas comprises the step of flooding the defined volume with a flow of chemically non-reactive gas selected from the group including nitrogen gas, carbon dioxide gas, helium gas, argon gas, neon gas, and mixtures of two or more thereof.

4. A method of suppressing a fire inside a defined volume within a structure, comprising the steps of:
storing a supply of inert gas under pressure;
providing at least one inert gas spray nozzle within the defined volume;
storing a supply of water in a reservoir in the vicinity of said at least one inert gas spray nozzle;
detecting a fire within the defined volume;
flooding the defined volume with pressurized inert gas by passing a flow of pressurized inert gas from said supply of inert gas through said at least one inert gas spray nozzle; and
pressurizing the water reservoir with a flow of pressurized inert from said supply of inert gas to force a flow of water from the water reservoir into the flow of pressurized inert gas.

5. A method of suppressing a fire as recited in claim 4 wherein the flow of inert gas and the limited amount of water introduced therein being sufficient to establish a fire extinguishing atmosphere within the defined volume having a volumetric oxygen concentration of at least about 14%.

6. A method of suppressing a fire as recited in claim 4 comprising the further step of introducing water from the water reservoir directly into the inert gas flow upstream of the spray nozzle.

7. A method of suppressing a fire as recited in claim 4 comprising the further step of introducing water from the water reservoir into the inert gas flow passing from the spray nozzle.

8. A method of suppressing a fire as recited in claim 7 wherein the flow of inert gas and the limited amount of water introduced therein being sufficient to establish a fire extinguishing atmosphere within the defined volume having a volumetric oxygen concentration of at least about 14%.

9. A method of suppressing a fire as recited in claim 4 further comprising the step of limiting the amount of water introduced into to the flow of inert gas to a mass flow ratio of the mass flow of water to the mass flow of inert gas in the range of about 0.02% to about 0.05%.

10. A method of suppressing a fire as recited in claim 4 wherein the step of flooding the defined volume with a flow of inert gas comprises the step of flooding the defined volume with a flow of chemically non-reactive gas selected from the group including nitrogen gas, carbon dioxide gas, helium gas, argon gas, neon gas, and mixtures of two or more thereof.

11. A fire suppression system for establishing a fire extinguishing atmosphere within a defined volume in response to detection of a fire within the defined volume, comprising:
at least one inert gas spray nozzle assembly for introducing a flooding flow of inert gas into the defined volume, said at least one inert gas spray nozzle assembly including a spray nozzle disposed within the defined volume and a water storage cartridge defining a reservoir for storing a limited amount of water in proximity to said spray nozzle, said spray nozzle in flow communication with a supply of pressurized inert gas, said water storage cartridge having a pressurizing gas inlet in flow communication with the supply of pressurized inert gas and a water outlet in flow communication with said spray nozzle.

12. A fire suppression system as recited in claim 11 wherein said water storage cartridge comprises an elongated body extending along a longitudinal axis between an aft end and a forward end and having an interior volume defining said water reservoir; the forward end of said body being disposed adjacent said spray nozzle.

13. A fire suppression system as recited in claim 12 further comprising a gas flow conduit establishing flow communication between the supply of pressurized inert gas and the interior volume of said water storage cartridge, the gas conduit having an outlet opening to the interior volume of said water storage cartridge through an upper portion of the aft end of said water storage cartridge.

14. A fire suppression system as recited in claim 12 further comprising a water conduit establishing flow communication between the interior volume of said water storage cartridge and said spray nozzle, the water conduit having an inlet opening to the interior volume of said water storage cartridge through a lower portion of the forward end of said water storage cartridge.

15. A fire suppression system as recited in claim 14 wherein said water conduit has an outlet opening into an interior cavity of said spray nozzle.

16. A fire suppression system as recited in claim 14 further comprising a flow restriction orifice disposed in said water conduit.

17. A fire suppression system as recited in claim 11 further comprising:
an inert gas supply pipe in flow communication the supply of pressurized inert gas, the inert gas supply pipe having a terminal portion having a terminus, said spray nozzle mounted to the terminus of the inert gas supply pipe.

18. A fire suppression system as recited in claim 17 further comprising:
a water conduit establishing flow communication between the interior volume of said water storage cartridge and said spray nozzle, the water conduit having an inlet opening to the interior volume of said water storage cartridge and an outlet opening into the terminal portion the inert gas supply pipe upstream with respect to inert gas flow therethrough of said spray nozzle.

19. A fire suppression system as recited in claim 18 further comprising a gas flow conduit establishing flow communication between the supply of pressurized inert gas and the interior volume of said water storage cartridge, the gas conduit having an inlet opening to an upstream portion of the terminal portion of the inert gas supply pipe and an outlet opening to the interior volume of said water storage cartridge through an upper portion of the aft end of said water storage cartridge

20. A fire suppression system as recited in claim 19 further comprising a flow restriction orifice disposed in the terminal portion of the inert gas supply pipe downstream with respect to inert gas flow of the inlet of the gas conduit to the terminal portion of the inert gas supply line and upstream with respect to inert gas flow of the outlet of the water conduit to the terminal portion of the inert gas supply pipe.
